(19) United States
(12) Patent Application Publication
(10) Pub. No.: US 2025/0125668 A1
(43) Pub. Date: Apr. 17, 2025

(54) CHARGING DEVICE

(71) Applicant: Panasonic Automotive Systems Co., Ltd., Kanagawa (JP)

(72) Inventors: Toshihiro OKUDA, Tokyo To (JP); Ryo TAKAYAMA, Kanagawa Ken (JP); Osamu IWABUCHI, Kanagawa Ken (JP); Mingxue ZHANG, Kanagawa Ken (JP); Dai KIMURA, Kanagawa Ken (JP); Atsutoshi NARAKI, Kanagawa Ken (JP); Satoshi TOMITA, Kanagawa Ken (JP)

(73) Assignee: Panasonic Automotive Systems Co., Ltd., Kanagawa (JP)

(21) Appl. No.: 18/999,726

(22) Filed: Dec. 23, 2024

Related U.S. Application Data
(63) Continuation of application No. PCT/JP2023/023158, filed on Jun. 22, 2023.

(30) Foreign Application Priority Data
Jun. 24, 2022 (JP) 2022-102140
Jul. 20, 2022 (JP) 2022-115334

(51) Int. Cl. H02J 50/90; H02J 50/00; H02J 50/10; H02J 50/40

(52) U.S. Cl. CPC H02J 50/90; H02J 50/005; H02J 50/10; H02J 50/402

(57) ABSTRACT

A charging device according to the present disclosure is a charging device wirelessly charging a terminal device that is placed on a placement surface to receive wirelessly transmitted power. The charging device includes a first charging coil, a magnet, and a moving mechanism. The first charging coil is configured to transmit power to the terminal device. The magnet is provided outside the first charging coil. The moving mechanism is configured to move the first charging coil and the magnet along the placement surface within a chargeable region corresponding to the placement surface.

### CROSS-REFERENCE TO RELATED APPLICATIONS

This application is a continuation of International Application No. PCT/JP2023/023158, filed on Jun. 22, 2023, which claims the benefit of priority of the prior Japanese Patent Applications No. 2022-102140, filed on Jun. 24, 2022, and No. 2022-115334, filed on Jul. 20, 2022, entire contents of which are incorporated herein by reference.

### FIELD

The present disclosure relates generally to a charging device.

### BACKGROUND

A charging device that performs wireless charging (contactless charging) on a terminal device incorporating a battery has been known.

In wireless charging, the closer a charging coil on the charging device side and an induction coil on the terminal device side to be charged are, the higher the charging efficiency is.

For example, a patent document WO 2013/047557 A discloses a magnet attraction type charging device that uses magnetic force for positioning (alignment) a terminal device. In the magnet attraction type charging device, the alignment of the charging coil and the induction coil is performed using the magnetic attraction force generated between the magnet arranged together with the charging coil and the magnet arranged together with the induction coil in the terminal device to be charged.

However, in a case where a terminal device in which a magnet is not arranged together with an induction coil is a charging target, a magnetic force from the magnet arranged together with the charging coil in the charging device affects the terminal device, and there is a possibility that the terminal device cannot be charged.

### SUMMARY

A charging device according to one aspect of the present disclosure is a charging device that wirelessly charges a terminal device, the terminal device being placed on a placement surface and receiving wirelessly transmitted power. The charging device includes a first charging coil, a magnet, and a moving mechanism. The first charging coil is configured to transmit power to the terminal device. The magnet is provided outside the first charging coil. The moving mechanism is configured to move the first charging coil and the magnet along the placement surface within a chargeable region corresponding to the placement surface.

### BRIEF DESCRIPTION OF DRAWINGS

FIG. 1 is a block diagram illustrating an example of a configuration of a charging device according to an embodiment;

FIG. 2 is a plan view schematically illustrating a configuration of a charging device according to a first embodiment;

FIG. 3 is a sectional view schematically illustrating a configuration of a charging device in FIG. 2;

FIG. 4 is a plan view schematically illustrating a configuration of a charging device according to a second embodiment;

FIG. 5 is a sectional view schematically illustrating a configuration of a charging device in FIG. 4;

FIG. 6 is a plan view schematically illustrating a configuration of a charging device according to a third embodiment;

FIG. 7 is a sectional view schematically illustrating a configuration of the charging device of FIG. 6;

FIG. 8 is a plan view schematically illustrating a configuration of a charging device according to a fourth embodiment;

FIG. 9 is a sectional view schematically illustrating a configuration of a charging device in FIG. 8;

FIG. 10 is a plan view schematically illustrating a configuration of a charging device according to a fifth embodiment;

FIG. 11 is a sectional view schematically illustrating a configuration of the charging device of FIG. 10;

FIG. 12 is a plan view schematically illustrating a configuration of a charging device according to a sixth embodiment;

FIG. 13 is a sectional view schematically illustrating a configuration of a charging device in FIG. 12;

FIG. 14 is a plan view schematically illustrating a configuration of a charging device according to a seventh embodiment;

FIG. 15 is a sectional view schematically illustrating a configuration of the charging device of FIG. 14;

FIG. 16 is a plan view schematically illustrating a configuration of a charging device according to an eighth embodiment;

FIG. 17 is a sectional view schematically illustrating a configuration of a charging device in FIG. 16;

FIG. 18 is a plan view schematically illustrating a configuration of a charging device according to a ninth embodiment;

FIG. 19 is a sectional view schematically illustrating a configuration of a charging device in FIG. 18;

FIG. 20 is a plan view schematically illustrating a configuration of a charging device according to a tenth embodiment, and is a view illustrating a configuration in a case where a magnet member is provided in the charging device and the terminal device is charged;

FIG. 21 is a sectional view schematically illustrating a configuration of the charging device of FIG. 20;

FIG. 22 is a plan view schematically illustrating a configuration of a charging device according to a tenth embodiment, and is a view illustrating a configuration in a case where a terminal device is charged without providing a magnet member in the charging device;

FIG. 23 is a sectional view schematically illustrating a configuration of the charging device of FIG. 22; and

FIG. 24 is a flowchart illustrating an example of an operation of the charging device according to the tenth embodiment.

### DETAILED DESCRIPTION

Hereinafter, an embodiment of a charging device according to the present disclosure will be described with reference to the drawings.

In the description of the present disclosure, components having the same or substantially the same functions as those described above with respect to the previously described drawings are denoted by the same reference numerals, and the description thereof may be appropriately omitted. In addition, even in the case of representing the same or substantially the same portion, the dimensions and ratios may be represented differently from each other depending on the drawings. Furthermore, for example, from the viewpoint of ensuring visibility of the drawings, in the description of each drawing, only main components are denoted by reference numerals, and even components having the same or substantially the same functions as those described above in the previous drawings may not be denoted by reference numerals.

A charging device according to the present disclosure is a terminal device (not illustrated) as an example of an electronic device incorporating a battery, and is a device that performs contactless charging, namely, wireless charging, on the terminal device arranged on a placement surface of the charging device.

The terminal device to be charged by the charging device is an electronic device configured to be drivable using power from a built-in battery. The battery is configured to be chargeable by power wirelessly transmitted from a charging device 1. Specifically, the terminal device further includes at least a power receiving unit. The power receiving unit is configured to be able to receive power wirelessly transmitted from the charging device. The power receiving unit is, for example, an induction coil electromagnetically coupled to a power transmission coil (charging coil) of the charging device. The power induced by the power receiving unit is supplied to the battery. As the terminal device, for example, various electronic devices such as a smartphone, a tablet terminal, an audio player, and a mobile phone can be appropriately used.

Here, wireless charging means that charging is performed wirelessly. In the present disclosure, a form in which wireless charging means charging by a magnetic induction action will be described as an example.

As an international standard of wireless charging, there is a Qi standard formulated by WPC (Wireless Power Consortium). In the Qi standard, charging by low power conveyance (hereinafter, referred to as “low-power charging”) and charging by high power conveyance (hereinafter, referred to as “high power charging”) are specified. For example, low-power charging is performed at a maximum of 5 W, and high-power charging is performed at 15 W or more. The low-power transmission is called BPP (Baseline Power Profile), and the high-power charging is called EPP (Extended Power Profile).

In such wireless charging, the closer to the positional relationship in which the charging coil of the charging device and the induction coil of the terminal device to be charged face each other, the more efficient the charging. In the Qi standard, MPP (Magnetic Power Profile) of high-speed charging using a magnet (magnet) for alignment is in a flow of standardization.

As an example, the alignment of the charging coil and the induction coil is performed using the magnetic attraction force generated between the magnet arranged together with the charging coil and the magnet arranged together with the induction coil in the terminal device to be charged.

As another example, in a state where the terminal device is placed on the upper surface of the charging device, the charging coil is moved so as to approach the induction coil, and the charging coil and the induction coil are aligned. In this case, no magnet for alignment is provided in the terminal device.

In the present disclosure, the charging device 1 in which the magnet for alignment is provided together with the charging coil is expressed as a “magnet-compatible charging device”. In addition, the charging device 1 in which the magnet for alignment is not provided is expressed as a “non-magnet compatible charging device” or a “BPP/EPP-compatible charging device”. Similarly, the terminal device to be charged in which the magnet for alignment is provided together with the induction coil is expressed as a “magnet-compatible terminal device”. In addition, the terminal device in which the magnet for alignment is not provided is expressed as a “non-magnet compatible terminal device” or a “BPP/EPP-compatible terminal device”. Here, the BPP/EPP-compatible means that it is compatible with at least one of BPP and EPP.

Under such circumstances, there has been a case where a magnetic force from a magnet of a magnet-compatible charging device affects a non-magnet compatible terminal device. Therefore, there is a case where the non-magnet compatible terminal device cannot be charged by the magnet-compatible charging device. On the other hand, when the magnet-compatible terminal device is charged by the non-magnet compatible charging device, there is a problem that high-speed charging of the MPP cannot be utilized although the terminal device is compatible with the magnet.

In other words, in the wireless charging by the magnet-compatible charging device including the magnet for alignment, there is a problem that it is not possible to charge the magnet-compatible terminal device and the non-magnet compatible terminal device at the same time.

Therefore, the present disclosure discloses a charging device configured to be able to charge both a magnet-compatible terminal device and a non-magnet compatible terminal device.

### First Embodiment

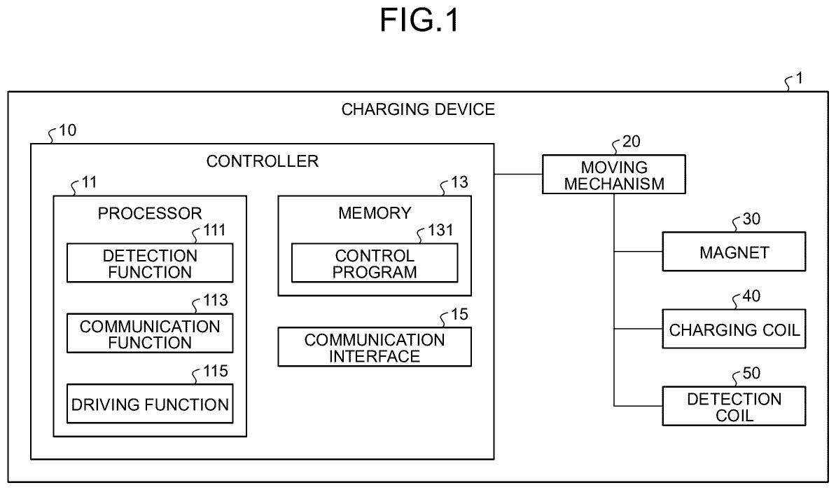

FIG. 1 is a block diagram illustrating an example of a configuration of a charging device 1 according to an embodiment.

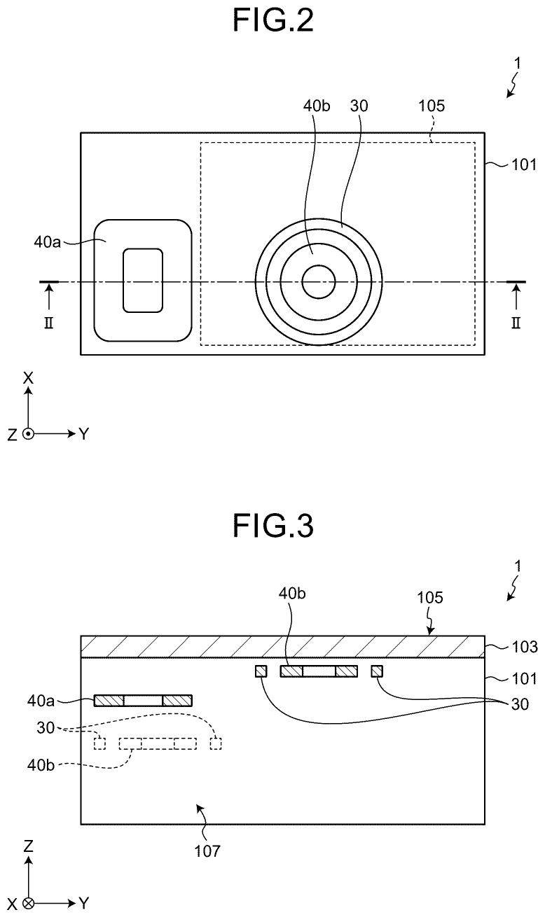

As illustrated in FIG. 1, a charging device 1 includes a controller 10, a moving mechanism 20, a magnet 30, a charging coil 40, and a detection coil 50. The controller 10, the moving mechanism 20, the magnet 30, the charging coil 40, and the detection coil 50 are provided in a housing 101 (refer to FIG. 2).

The controller 10 is configured to control the operation of the charging device 1. The controller 10 includes a processor 11, a memory 13, and a communication interface 15.

The processor 11 controls the overall operation of the controller 10. The processor 11 reads a control program 131 stored in, for example, a ROM (Read Only Memory) of the memory 13 and executes the program loaded in a RAM (Random Access Memory) of the memory 13, thereby implementing functions as a detection function 111, a communication function 113, and A driving function 115.

As the processor, various processors such as a CPU (Central Processing Unit), a GPU (Graphics Processing Unit), an ASIC (Application Specific Integrated Circuit), and an FPGA (Field Programmable Gate Array) can be used as appropriate.

In the detection function 111, the processor 11 is configured to output a signal for generating a magnetic field for detection to the detection coil 50. In addition, the processor 11 is configured to determine the arrangement position of the terminal device to be charged on the basis of an input of an echo signal that is responded to the detection coil 50 from the terminal device in response to the detection magnetic field generated by the detection coil 50.

In the communication function 113, the processor 11 is configured to communicate with the terminal device by the charging coil 40 when the charging coil 40 moves to the arrangement position of the terminal device by the control of the driving function 115. The processor 11 is configured to determine whether the terminal device to be charged is a magnet-compatible terminal device or a non-magnet compatible terminal device by communication with the terminal device.

In the driving function 115, the processor 11 is configured to drive the charging coil 40 compatible with the terminal device to be charged and cause the charging coil 40 to transmit power. Specifically, the processor 11 controls the AC power supply to supply the AC power from the AC power supply (not illustrated) to the charging coil 40. The charging coil 40 is configured to supply AC power to the induction coil of the terminal device by being electromagnetically coupled to the induction coil. The AC power supplied to the induction coil is converted into DC power by a rectifier provided in the terminal device, and the battery built in the terminal device is charged. As a result, the battery of the terminal device is wirelessly charged. Note that the AC power supply may be provided inside the charging device 1 or may be provided as an external power supply of the charging device 1.

In the driving function 115, the processor 11 is configured to drive the moving mechanism 20 to move the charging coil 40 compatible with the terminal device to be charged from a retraction region 107 to the chargeable region. In addition, the processor 11 is configured to drive the moving mechanism 20 to horizontally move, to the charging position within the chargeable region, the charging coil 40 compatible with the terminal device to be charged.

Here, the retraction region 107 is a position deviated from the chargeable region below a placement surface 105 in the direction along the placement surface 105 (horizontal direction). The retraction region 107 is a position (in the horizontal direction) on an X-Y plane where the influence of the magnetic force from the magnet 30 on the retraction region 107 is sufficiently small, which is an influence on the non-magnet compatible terminal device placed on the placement surface 105. Note that the position where each of the charging coils 40 is stored in the retraction region 107 may be predetermined or any position.

Note that the influence of the magnetic force from the magnet 30 is preferably negligibly small, but the present invention is not limited thereto. There may be a case where the size of the charging device 1 is limited, such as a case where the charging device 1 is configured as an in-vehicle device. Therefore, the retraction region 107 can be set such that the influence of the magnetic force from the magnet 30 is smaller than at least the chargeable region.

The chargeable region is a region corresponding to the placement surface 105. Specifically, the chargeable region is a region in the vicinity of a panel 103 in a Z-axis direction below the placement surface 105 and at a position facing the placement surface 105. In other words, the chargeable region is a position in the Z-axis direction where the power can be wirelessly transmitted to the power receiving unit (induction coil) of the terminal device placed on the placement surface 105 via the panel 103.

In addition, the charging position is a position corresponding to the arrangement position of the terminal device in the chargeable region. Typically, the positions of the charging position and the arrangement position in the horizontal direction, namely, the positions in an X-Y plane viewed from the upper surface side match with each other.

As an example, in a case where the charging target is a non-magnet compatible terminal device, the processor 11 moves a charging coil 40a (charging coil 40) from the retraction region 107 to the charging position within the chargeable region. Here, the charging coil 40a is an example of a second charging coil.

As an example, in a case where the charging target is a magnet-compatible terminal device, the processor 11 moves the magnet 30 and a charging coil 40b (charging coil 40) from the retraction region 107 to the charging position in the chargeable region. Here, the charging coil 40b is an example of a first charging coil.

As a hardware configuration, various storage media and storage devices such as a ROM, an HDD (Hard Disk Drive), an SSD (Solid State Drive), and a flash memory can be appropriately used as the memory 13. The memory 13 is further provided with a RAM for temporarily storing working data. The memory 13 stores various data and programs used by the controller 10.

The communication interface 15 is configured to be able to wirelessly communicate with a terminal device to be charged. The communication interface 15 includes a communication circuit for wireless communication as a hardware configuration. As a communication circuit for wireless communication, a communication circuit compatible with various standards such as 4G, 5G, 6G, Wi-Fi (registered trademark), Bluetooth (registered trademark), and infrared communication can be appropriately used.

FIG. 2 is a plan view schematically illustrating a configuration of a charging device 1 according to the first embodiment. FIG. 2 illustrates a case where the charging device 1 is viewed from above. FIG. 3 is a sectional view schematically illustrating a configuration of the charging device 1 of FIG. 2. FIG. 3 illustrates a cross section taken along line II-II in FIG. 2.

In the present disclosure, for example, as illustrated in FIGS. 2 and 3, an orthogonal coordinate system including an X-axis, a Y-axis, and a Z-axis is defined. The X-axis, the Y-axis, and the Z-axis are orthogonal to each other. The Z-axis is perpendicular to the X-axis and the Y-axis and extends in the thickness direction of the charging device 1. For each of the X-axis, the Y-axis, and the Z-axis, the positive direction is defined by, for example, a direction of an arrow illustrated in FIGS. 2 and 3. Similarly, the negative direction is defined by the direction opposite to the arrow. In the present disclosure, the positive direction of the Z-axis may be referred to as “above”, “upper side”, or “upper surface side”. Similarly, the negative direction of the Z-axis may be referred to as “below”, “lower side”, or “lower surface side”.

Note that, in the present disclosure, “parallel”, “horizontal”, “vertical”, and “orthogonal” include not only complete parallel, horizontal, vertical, and orthogonal, but also cases of being deviated from parallel, horizontal, vertical, and orthogonal within an error range. In addition, “substantially” means the same in an approximate range.

The charging device 1 includes a housing 101 and a panel 103. The combination of the housing 101 and the panel 103 has, for example, a box shape. The panel 103 is detachably attached to the upper side of the housing 101 with respect to the housing 101.

A controller 10, a moving mechanism 20, a magnet 30, a charging coil 40, and a detection coil 50 are provided inside the housing 101 and the panel 103.

In the housing 101, the moving mechanism 20 movably supports the magnet 30 and/or the charging coil 40 as described later.

The placement surface 105 is provided on the upper surface side of the panel 103. It is assumed that the placement surface 105 is a region on which a wireless charging target, namely, a terminal device is placed, and is a region in which the terminal device can be charged. Note that the actual chargeable range of the terminal device on the placement surface 105 can vary depending on the movable range of the charging coil 40, compatibility or the like between the charging coil 40 and the induction coil of the terminal device.

In the present embodiment, a case where the placement surface 105 is a partial region of the outer surface of the panel 103 and is a two-dimensional planar region will be exemplified. Thus, in the present embodiment, the X-axis direction and the Y-axis direction are directions orthogonal to each other along the two-dimensional plane of the placement surface 105. Further, the description will be given assuming that the Z-axis direction orthogonal to the X-axis direction and the Y-axis direction correspond to the thickness direction of the housing 101.

The moving mechanism 20 is configured to support the charging coil 40a. Similar to the example of the charging coil 40b in FIG. 3, the moving mechanism 20 is configured to move the charging coil 40a between the chargeable region below the placement surface 105 and the retraction region 107 under the control of the controller 10. The moving mechanism 20 is configured to move the charging coil 40a along the placement surface 105, namely, in the X-Y plane, within the chargeable region under the control of the controller 10. For example, the moving mechanism 20 includes a motor for moving the charging coil 40a in each of the X-axis, Y-axis, and Z-axis directions.

The moving mechanism 20 is configured to support the magnet 30 and the charging coil 40b. As illustrated in FIG. 3, the moving mechanism 20 is configured to move the magnet 30 and the charging coil 40b between the chargeable region below the placement surface 105 and the retraction region 107 under the control of the controller 10. The moving mechanism 20 is configured to move the magnet 30 and the charging coil 40b along the placement surface 105, within the chargeable region under the control of the controller 10. For example, the moving mechanism 20 includes a motor for moving the magnet 30 and the charging coil 40b in each of the X-axis, Y-axis, and Z-axis directions.

As described above, the moving mechanism 20 according to the present embodiment is configured to move any one of the charging coil 40a and the set of the magnet 30 and the charging coil 40b from the retraction region 107 to the chargeable region and horizontally move the other one within the chargeable region, for example, like a CD changer.

Note that the motor that moves the charging coil 40a and the motor that moves the magnet 30 and the charging coil 40b may be a common motor or may be separate motors. The motors to be moved in the X-axis, Y-axis, and Z-axis directions may be common motors or may be separate motors in the respective directions.

The magnet 30 is, for example, a permanent magnet, but may be an electromagnet. The magnet 30 is formed in an annular shape. In other words, the magnet 30 has a substantially cylindrical shape. The magnet 30 is concentrically arranged outside the charging coil 40b. As an example, the magnet 30 is attached to the outer periphery of the charging coil 40b. As an example, the magnet 30 is supported by the moving mechanism 20 together with the charging coil 40b.

The charging coil 40 is a coil for transmitting power to the terminal device placed on the placement surface 105. As illustrated in FIGS. 2 and 3, the charging coil 40 includes a charging coil 40a and a charging coil 40b.

The charging coil 40a is a coil for transmitting power to the non-magnet compatible terminal device. For example, as illustrated in FIG. 2, the charging coil 40a is formed in a hollow substantially rectangular shape.

The charging coil 40b is a coil for transmitting power to the magnet-compatible terminal device. For example, as illustrated in FIG. 2, the charging coil 40b is formed in an annular shape. In other words, the charging coil 40b has a substantially cylindrical shape.

The detection coil 50 is a coil for detecting an arrangement position of the terminal device on the placement surface 105. The arrangement position of the terminal device represents the position of the power receiving unit (induction coil) provided in the terminal device. The arrangement position of the terminal device is represented by a position on the placement surface 105. For example, the detection coil 50 is disposed along the placement surface 105 inside the placement surface 105. As an example, a plurality of detection coils 50 is arranged along each of the X-axis direction and the Y-axis direction in a two-dimensional plane along the placement surface 105.

In the example illustrated in FIG. 3, the position in the Z-axis direction at which the charging coil 40 moves within the chargeable region below the placement surface 105 is different from the position in the Z-axis direction in the retraction region 107 of each charging coil 40, but the present invention is not limited thereto. The position in the Z-axis direction in the retraction region 107 of at least one of the charging coil 40a and the charging coil 40b may coincide with the position in the Z-axis direction in the chargeable region. Further, the position of the chargeable region in the Z-axis direction may be different between the charging coil 40a and the charging coil 40b.

As an example, in the example illustrated in FIG. 3, the charging coil 40a may horizontally move on the X-Y plane within the chargeable region while maintaining the position in the Z-axis direction in the retraction region 107.

As an example, in the example illustrated in FIG. 3, the charging coil 40b may be stored in the retraction region 107 while maintaining the position in the Z-axis direction when horizontally moving on the X-Y plane in the chargeable region.

As described above, the charging device 1 according to the present embodiment is configured to replace the charging coil 40 moved to the chargeable region or the charging position below the placement surface 105 according to the terminal device to be charged. Specifically, the charging coil 40 to be moved to the chargeable region or the charging position is determined according to whether the terminal device to be charged is compatible with the magnet or not compatible with the magnet.

According to this configuration, it is possible to perform high-speed charging of MPP for the magnet-compatible terminal device and to perform charging of BPP or EPP for the non-magnet compatible terminal device. Therefore, in the magnet-compatible charging device 1, it is possible to suppress the magnetic force from the magnet 30 from affecting the non-magnet compatible terminal device. As a result, in wireless charging by the magnet-compatible charging device including the magnet 30 for alignment, it is possible to charge the magnet-compatible terminal device and the non-magnet compatible terminal device.

Hereinafter, another embodiment of a charging device 1 according to the present disclosure will be described with reference to the drawings. Note that, in the following description of each embodiment, description of contents overlapping with the above-described contents is appropriately omitted.

### Second Embodiment

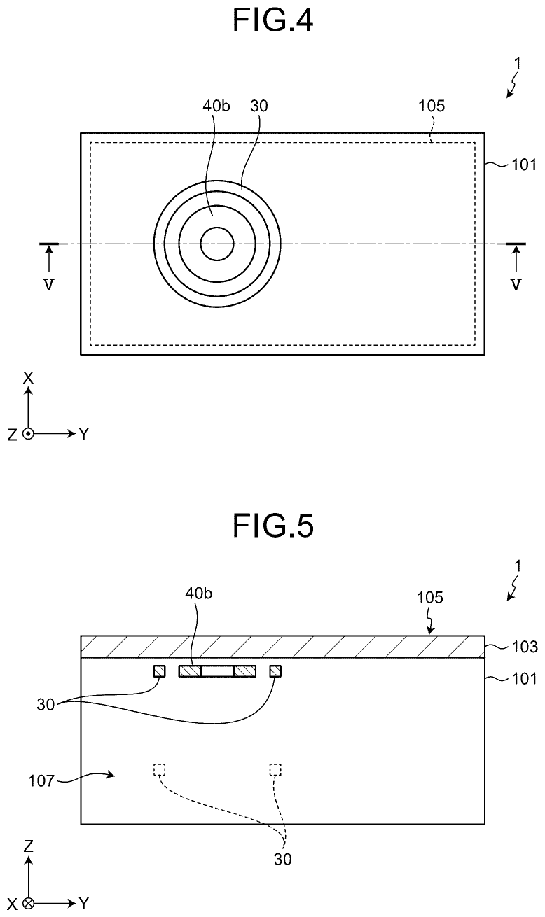

In the present embodiment, differences from the first embodiment will be mainly described. FIG. 4 is a plan view schematically illustrating a configuration of a charging device 1 according to the second embodiment. FIG. 4 illustrates a case where the charging device 1 is viewed from above. FIG. 5 is a sectional view schematically illustrating a configuration of the charging device 1 of FIG. 4. FIG. 5 illustrates a cross section taken along line V-V in FIG. 4.

As illustrated in FIGS. 4 and 5, the charging device 1 according to the present embodiment includes a charging coil 40b as the charging coil 40. In other words, in the present embodiment, the charging device 1 does not include the charging coil 40a for a non-magnet compatible terminal device. In addition, the charging device 1 does not include the moving mechanism 20 for the charging coil 40a.

The placement surface 105 according to the present embodiment is provided over substantially the entire upper surface side of the panel 103. Thus, the placement surface 105 according to the present embodiment further includes a range above the retraction region 107 in the first embodiment on the upper surface side of the panel 103. In the example of FIG. 4, the placement surface 105 is provided over substantially the entire upper surface side of the panel 103, but the present invention is not limited thereto. The placement surface 105 may be provided over substantially the entire surface of the upper surface side of the panel 103 in one of the X-axis direction and the Y-axis direction, or may be provided over a part of the upper surface side of the panel 103 in each of the X-axis direction and the Y-axis direction.

The moving mechanism 20 according to the present embodiment is configured to independently support the magnet 30 and the charging coil 40b. Under the control of the controller 10, the moving mechanism 20 is configured to move at least the charging coil 40b of the magnet 30 and the charging coil 40b along the placement surface 105 within the chargeable region. As illustrated in FIG. 5, the moving mechanism 20 is configured to move the magnet 30 between the chargeable region and the retraction region 107 provided further below the chargeable region under the control of the controller 10.

Here, the retraction region 107 according to the present embodiment is a region deviated from the chargeable region in the direction (downward) intersecting the direction (horizontal direction) along the placement surface 105. The retraction region 107 is a position in the Z-axis direction below the chargeable region and at which the influence of the magnetic force from the magnet 30 on the non-magnet compatible terminal device placed on the placement surface 105 is sufficiently small.

The magnet 30 according to the present embodiment is independently supported by the moving mechanism 20 together with the charging coil 40b.

In the driving function 115 according to the present embodiment, the processor 11 is configured to drive the moving mechanism 20 to move the charging coil 40b to the charging position in the chargeable region. Further, the processor 11 is configured to move the magnet 30 to the chargeable region or the retraction region 107 according to the terminal device.

As an example, in a case where the charging target is a non-magnet compatible terminal device, the processor 11 moves the charging coil 40b to the charging position in the chargeable region. In addition, the processor 11 moves the magnet 30 from the chargeable region to the retraction region 107.

As an example, in a case where the charging target is a magnet-compatible terminal device, the processor 11 moves the magnet 30 and the charging coil 40b to the charging position in the chargeable region.

Note that the positions in the horizontal direction of the magnet 30 and the charging coil 40b, namely, the positions in the X-Y plane viewed from the upper surface side may be different from each other, except when the magnet 30 and the charging coil 40b move the position in the Z-axis direction in the vicinity of the panel 103 below the placement surface 105 at the time of wireless charging to the magnet-compatible terminal device.

The magnet 30 and the charging coil 40b may be independently moved in at least one of the X-axis direction, the Y-axis direction, and the Z-axis direction to be moved to a position in the Z-axis direction in the vicinity of the panel 103 below the placement surface 105.

The retraction region 107 is not limited to below the placement surface 105, and may be provided at a position deviated in the horizontal direction from below the placement surface 105 as in the first embodiment. Thus, only the magnet 30 may be retracted in the horizontal direction similarly to the first embodiment.

As described above, the charging device 1 according to the present embodiment is configured to be able to move the magnet 30 between the chargeable region and the retraction region 107 depending on whether the terminal device to be charged is compatible with the magnet or not compatible with the magnet.

According to this configuration, in the magnet-compatible charging device 1 in which the charging coil 40a for the non-magnet compatible terminal device is not provided, it is possible to suppress the magnetic force from the magnet 30 from affecting the non-magnet compatible terminal device.

In addition, the horizontal range of the placement surface 105, namely, the chargeable region in the charging device 1 can be enlarged.

### Third Embodiment

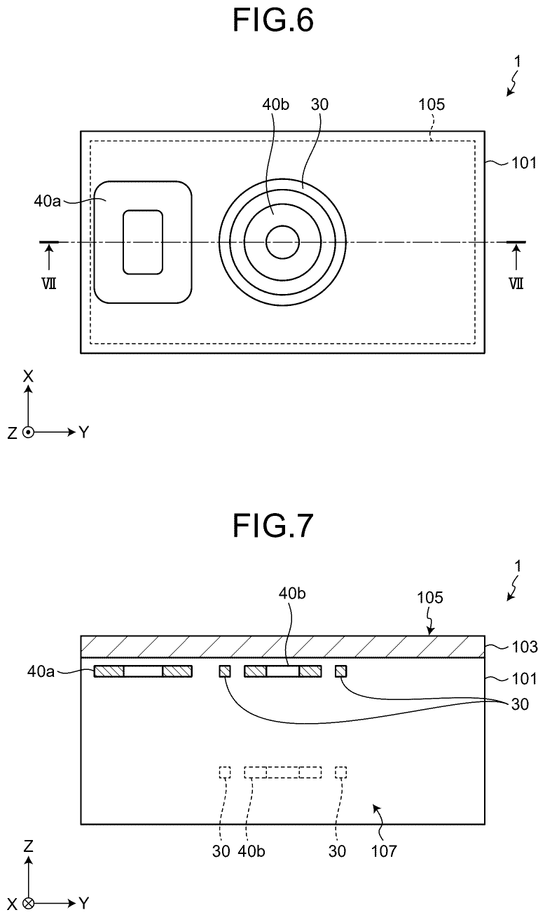

In the present embodiment, differences from the first embodiment will be mainly described. FIG. 6 is a plan view schematically illustrating a configuration of a charging device according to the third embodiment. FIG. 6 illustrates a case where the charging device 1 is viewed from above. FIG. 7 is a sectional view schematically illustrating a configuration of the charging device of FIG. 6. FIG. 7 illustrates a cross section taken along line VII-VII in FIG. 6.

As illustrated in FIGS. 6 and 7, the charging device 1 according to the present embodiment includes a charging coil 40a and a charging coil 40b as the charging coil 40, for example, similarly to the first embodiment.

The placement surface 105 according to the present embodiment is provided over substantially the entire upper surface side of the panel 103. Thus, the placement surface 105 according to the present embodiment further includes a range above the retraction region 107 in the first embodiment on the upper surface side of the panel 103.

As illustrated in FIG. 7, the moving mechanism 20 according to the present embodiment is configured to move the magnet 30 and the charging coil 40b between the chargeable region and the retraction region 107 below the placement surface 105 under the control of the controller 10.

Here, as in the second embodiment, the retraction region 107 according to the present embodiment is a position in the Z-axis direction below the chargeable region below the placement surface 105 and at which the influence of the magnetic force from the magnet 30 on the non-magnet compatible terminal device placed on the placement surface 105 is sufficiently small.

In the driving function 115 according to the present embodiment, the processor 11 is configured to drive the moving mechanism 20 to move the magnet 30 and the charging coil 40b compatible with the terminal device to be charged between the retraction region 107 and the chargeable region.

As an example, in a case where the charging target is a non-magnet compatible terminal device, the processor 11 moves the magnet 30 and the charging coil 40b to the retraction region 107 from the chargeable region. In addition, the processor 11 moves the charging coil 40a to the charging position in the chargeable region.

As an example, in a case where the charging target is a magnet-compatible terminal device, the processor 11 moves the magnet 30 and the charging coil 40b to the charging position in the chargeable region. At this time, when the charging coil 40a is positioned above the magnet 30 and the charging coil 40b, the processor 11 horizontally moves the charging coil 40a to another position of the charging position in the chargeable region prior to the magnet 30 and the charging coil 40b.

Note that the positions in the Z-axis direction of the chargeable regions between the charging coil 40a and the charging coil 40b may correspond to each other as illustrated in FIG. 7 or may be different from each other. When the positions of the chargeable region in the Z-axis direction correspond to each other, the charging coil 40a may be moved in the vertical direction (Z-axis direction) in order to avoid interference when the magnet 30 and the charging coil 40b are horizontally moved in the chargeable region. In this case, the movement of the charging coil 40a in the Z-axis direction can be performed above the retraction region 107. As a result, it is possible to appropriately move each charging coil 40 while bringing the chargeable region close to the terminal device.

As described above, the charging device 1 according to the present embodiment is configured to be able to move the magnet 30 and the charging coil 40b between the chargeable region and the retraction region 107, namely, in the vertical direction (Z-axis direction) according to whether the terminal device to be charged is compatible with the magnet or not compatible with the magnet.

Even with this configuration, the same effects as those of the above-described embodiment can be obtained.

### Fourth Embodiment

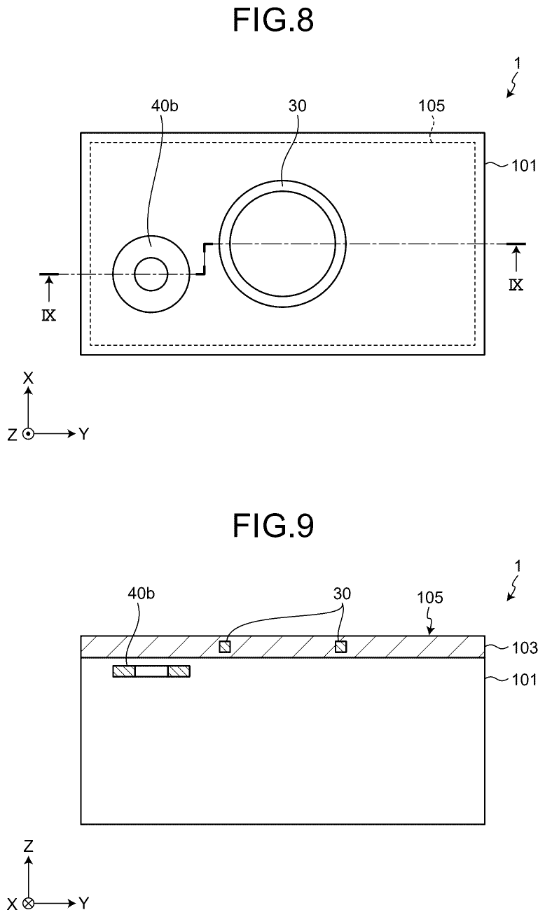

In the present embodiment, differences from the second embodiment will be mainly described. FIG. 8 is a plan view schematically illustrating a configuration of a charging device according to the fourth embodiment. FIG. 8 illustrates a case where the charging device 1 is viewed from above. FIG. 9 is a sectional view schematically illustrating a configuration of the charging device of FIG. 8. FIG. 9 illustrates a cross section taken along line IX-IX in FIG. 8.

The magnet 30 according to the present embodiment is fixed to the panel 103. In other words, the charging device 1 does not include the moving mechanism 20 for the magnet 30. The magnet 30 is provided, for example, at the center of the placement surface 105. The magnet 30 is configured as an electromagnet. The magnet 30 is configured to turn ON/OFF the generation of the magnetic force according to the control of the controller 10.

The magnet 30 is not limited to the panel 103, and may be fixed and provided on the housing 101 side.

The moving mechanism 20 according to the present embodiment is configured to support the charging coil 40b. As illustrated in FIG. 9, the moving mechanism 20 is configured to move the charging coil 40b along the placement surface 105 within the chargeable region under the control of the controller 10.

In the charging device 1 according to the present embodiment, the retraction region 107 is not provided.

In the driving function 115 according to the present embodiment, the processor 11 is configured to drive the moving mechanism 20 to move the charging coil 40b to the charging position in the chargeable region. In addition, the processor 11 is configured to drive the magnet 30 to switch ON/OFF of the generation of the magnetic force of the magnet 30 according to the terminal device to be charged.

As an example, in a case where the charging target is the non-magnet compatible terminal device, the processor 11 moves the charging coil 40b to the charging position in the chargeable region, and turns OFF the generation of the magnetic force by the magnet 30.

As an example, in a case where the charging target is the magnet-compatible terminal device, the processor 11 moves the charging coil 40b to the charging position in the chargeable region, and turns ON the generation of the magnetic force by the magnet 30. In short, the processor 11 turns ON the magnet 30 when the charging coil 40b is moved to the charging position.

Here, the charging position of the magnet-compatible terminal device according to the present embodiment is below the position where the magnet 30 is provided in the chargeable region. Further, the charging position is positioned inside the magnet 30. On the other hand, the charging position for the non-magnet compatible terminal device is a position corresponding to the arrangement position of the terminal device in the chargeable region.

As described above, the charging device 1 according to the present embodiment is configured to be able to switch ON/OFF of the magnet 30 configured as an electromagnet according to whether the terminal device to be charged is compatible with the magnet or not compatible with the magnet.

Even with this configuration, the same effects as those of the second embodiment can be obtained. In addition, the moving mechanism 20 for the magnet 30 is unnecessary, and the charging device 1 can have a simple configuration. As a result, the number of components and cost of the charging device 1 can be reduced, and maintainability can be improved.

### Fifth Embodiment

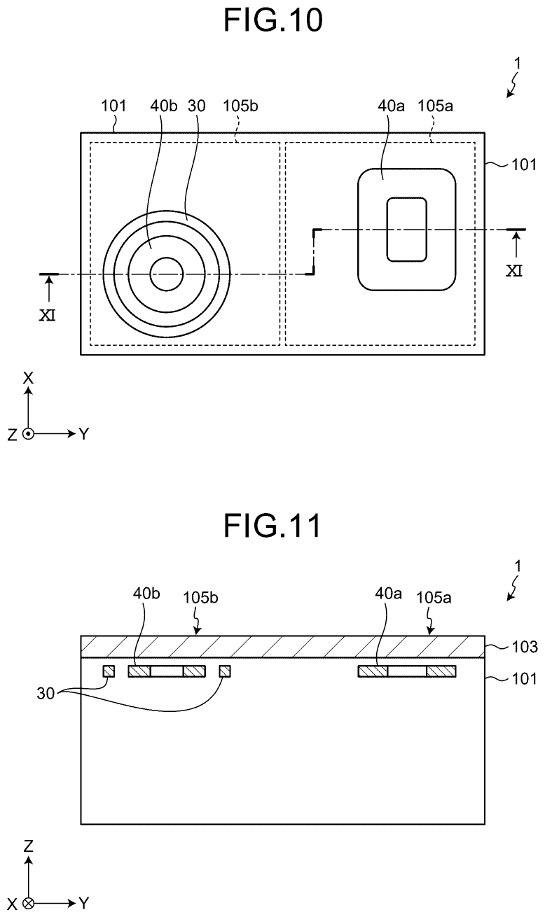

In the present embodiment, differences from the first embodiment will be mainly described. FIG. 10 is a plan view schematically illustrating a configuration of a charging device according to the fifth embodiment. FIG. 10 illustrates a case where the charging device 1 is viewed from above. FIG. 11 is a sectional view schematically illustrating a configuration of the charging device of FIG. 10. FIG. 11 illustrates a cross section taken along line XI-XI in FIG. 10.

As illustrated in FIGS. 10 and 11, the charging device 1 according to the present embodiment includes a placement surface 105a for the non-magnet compatible terminal device and a placement surface 105b for the magnet-compatible terminal device. In other words, the placement surface 105 according to the present embodiment is divided into a placement surface 105a for the non-magnet compatible terminal device and a placement surface 105b for the magnet-compatible terminal device. The placement surface 105a and the placement surface 105b are adjacent to each other in a direction (horizontal direction) along the placement surface 105. Here, the placement surface 105a is an example of a second placement surface. The placement surface 105b is an example of a first placement surface.

The moving mechanism 20 according to the present embodiment is configured to move the charging coil 40a along the placement surface 105a within the chargeable region below the placement surface 105a under the control of the controller 10.

Further, the moving mechanism 20 is configured to move the magnet 30 and the charging coil 40b along the placement surface 105b within the chargeable region below the placement surface 105b under the control of the controller 10.

In the charging device 1 according to the present embodiment, the retraction region 107 is not provided.

As described above, the charging device 1 according to the present embodiment includes a placement surface 105a for the non-magnet compatible terminal device and a placement surface 105b for the magnet-compatible terminal device.

Even with this configuration, the same effects as those of the first embodiment can be obtained. In addition, since the retraction region 107 is unnecessary, the horizontal range of the placement surface 105, namely, the chargeable region in the charging device 1 can be enlarged.

### Sixth Embodiment

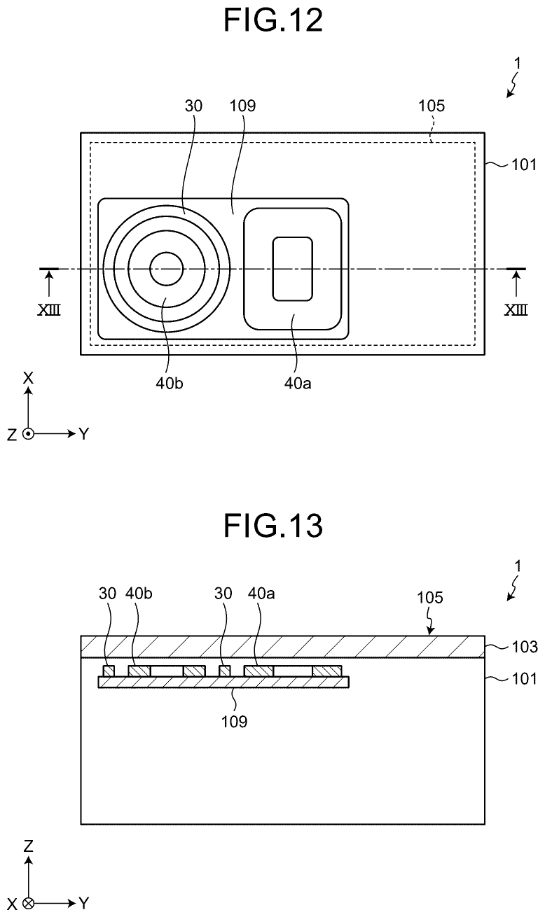

In the present embodiment, differences from the first embodiment will be mainly described. FIG. 12 is a plan view schematically illustrating a configuration of a charging device according to the sixth embodiment. FIG. 12 illustrates a case where the charging device 1 is viewed from above. FIG. 13 is a sectional view schematically illustrating a configuration of the charging device of FIG. 12. FIG. 13 illustrates a cross section taken along line XIII-XIII in FIG. 12.

As illustrated in FIGS. 12 and 13, the charging device 1 according to the present embodiment further includes a support base 109. The support base 109 is configured to fix and support the magnet 30, the charging coil 40a, and the charging coil 40b. In other words, in the charging device 1 according to the present embodiment, the magnet 30, the charging coil 40a, and the charging coil 40b are integrally configured.

The placement surface 105 according to the present embodiment is provided over substantially the entire upper surface side of the panel 103, for example, as in the third embodiment.

The moving mechanism 20 according to the present embodiment is configured to support the support base 109. The moving mechanism 20 is configured to move the support base 109 along the placement surface 105 within the chargeable region under the control of the controller 10.

In the charging device 1 according to the present embodiment, the retraction region 107 is not provided.

In the driving function 115 according to the present embodiment, the processor 11 is configured to drive the moving mechanism 20 to move the support base 109 such that the charging coil 40b is positioned at the charging position.

As an example, in a case where the charging target is the non-magnet compatible terminal device, the processor 11 moves the support base 109 so that the charging coil 40b is positioned at the charging position.

As an example, in a case where the charging target is the magnet-compatible terminal device, the processor 11 moves the support base 109 so that the magnet 30 and the charging coil 40b are positioned at the charging position.

In the example of FIG. 13, the positions of the magnet 30, the charging coil 40a, and the charging coil 40b in the Z-axis direction correspond to each other, but the present invention is not limited thereto. The magnet 30, the charging coil 40a, and the charging coil 40b may be fixed to the support base 109 such that the positions in the Z-axis direction are different from the others. For example, in order to reduce the influence of the magnetic force of the magnet 30 on the non-magnet compatible terminal device, the magnet 30 may be positioned below at least one of the charging coil 40a and the charging coil 40b.

The number of the charging coils 40 arranged on the support base 109 is not limited. For example, in the support base 109, the magnet 30 and the charging coil 40b may be provided between the two charging coils 40a.

As described above, the charging device 1 according to the present embodiment is configured to control the positions of the magnet 30 and the charging coil 40 integrally configured according to whether the terminal device to be charged is compatible with the magnet or not compatible with the magnet.

Even with this configuration, the same effects as those of the fifth embodiment can be obtained.

### Seventh Embodiment

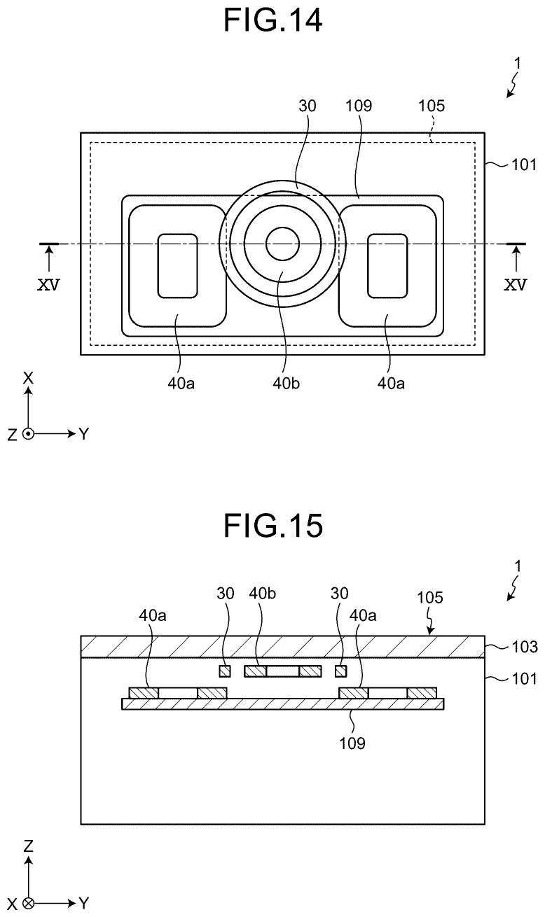

In the present embodiment, differences from the sixth embodiment will be mainly described. FIG. 14 is a plan view schematically illustrating a configuration of a charging device according to the seventh embodiment. FIG. 14 illustrates a case where the charging device 1 is viewed from above. FIG. 15 is a sectional view schematically illustrating a configuration of the charging device of FIG. 14. FIG. 15 illustrates a cross section taken along line XV-XV in FIG. 14.

The charging device 1 according to the present embodiment includes a plurality of the charging coils 40a. FIGS. 14 and 15 illustrate the charging device 1 having two of the charging coils 40a. The charging coils 40a are fixed to the support base 109.

The magnet 30 and the charging coil 40b according to the present embodiment are fixed to the housing 101. As an example, the magnet 30 and the charging coil 40b are fixedly provided within a region corresponding to the placement surface 105. Thus, the charging device 1 does not include the moving mechanism 20 for the magnet 30 and the charging coil 40b. The magnet 30 and the charging coil 40b are provided, for example, at positions facing the center of the placement surface 105.

The magnet 30 and the charging coil 40b are not limited to the housing 101, and may be fixed and provided on the panel 103 side. One of the magnet 30 and the charging coil 40b may be provided on the housing 101 side, and the other may be provided on the panel 103 side.

The number of the charging coils 40a may be three or more. For example, the charging coils 40a are arranged point-symmetrically on the support base 109.

As described above, while the magnet 30 and the charging coil 40b for the magnet-compatible terminal device are fixed, the charging device 1 according to the present embodiment includes the plurality of charging coils 40a for the non-magnet compatible terminal device configured to be movable.

Even with this configuration, the same effects as those of the sixth embodiment can be obtained. In addition, the non-magnet compatible terminal device cannot be aligned by magnetic attraction, but since the charging coils 40a are provided, the accuracy of alignment with respect to the arrangement position of the terminal device can be improved even in the non-magnet compatible terminal device, and the charging coil 40a and the induction coil can be brought closer to each other.

### Eighth Embodiment

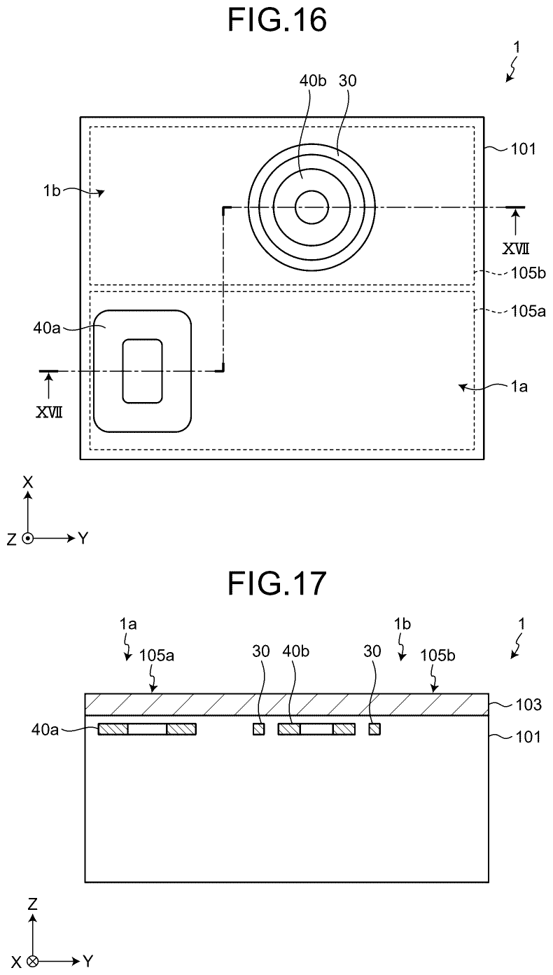

In the present embodiment, differences from the fifth embodiment will be mainly described. FIG. 16 is a plan view schematically illustrating a configuration of a charging device according to the eighth embodiment. FIG. 16 illustrates a case where the charging device 1 is viewed from above. FIG. 17 is a sectional view schematically illustrating a configuration of the charging device of FIG. 16. FIG. 17 illustrates a cross section taken along line XVII-XVII in FIG. 16.

As illustrated in FIGS. 16 and 17, the charging device 1 according to the present embodiment has a configuration in which a charging device 1a for the non-magnet compatible terminal device and a charging device 1b for the magnet-compatible terminal device are combined. In other words, the housing 101 of the charging device 1 according to the present embodiment stores the charging device 1a for the non-magnet compatible terminal device and the charging device 1b for the magnet-compatible terminal device.

Note that the housings of the charging devices 1a and 1b are integrally formed as, for example, the housing 101 of the charging device 1, but may have independent housings.

The charging device 1a for the non-magnet compatible terminal device has each configuration corresponding to the placement surface 105a for the non-magnet compatible terminal device according to the fifth embodiment.

Similarly, the charging device 1b for the magnet-compatible terminal device has each configuration corresponding to the placement surface 105b for the magnet-compatible terminal device according to the fifth embodiment.

Note that a part of the controller 10 and the moving mechanism 20 may be common between the charging devices 1a and 1b.

As described above, the charging device 1 according to the present embodiment has a configuration in which the charging device 1a for the non-magnet compatible terminal device and the charging device 1b for the magnet-compatible terminal device are integrally formed.

Even with this configuration, the same effects as those of the fifth embodiment can be obtained. In addition, when the charging device 1a for the non-magnet compatible terminal device and the charging device 1b for the magnet-compatible terminal device are separately manufactured, the charging device 1 can be more easily realized. In addition, even after release, for example, when any standard is changed or abolished or when a new standard is formulated, one charging device can be replaced with a charging device of another standard.

### Ninth Embodiment

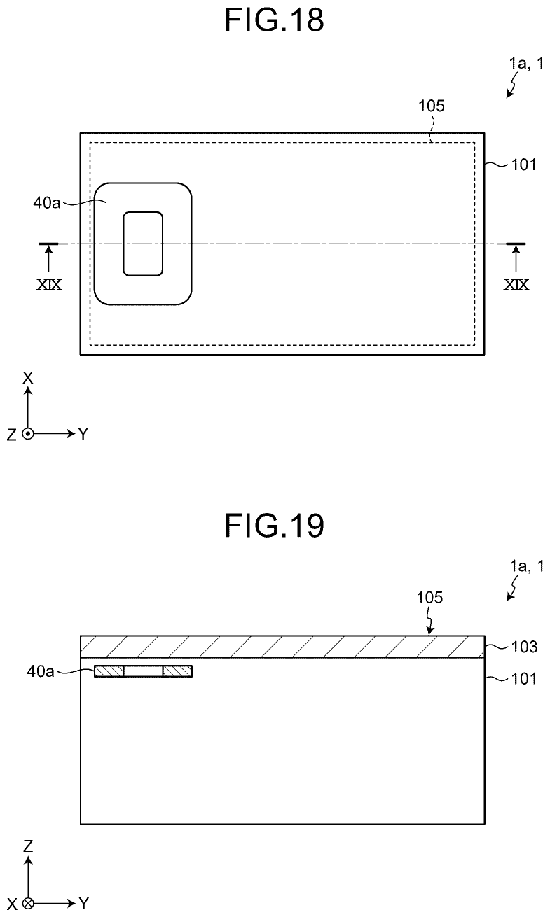

In the present embodiment, differences from the eighth embodiment will be mainly described. FIG. 18 is a plan view schematically illustrating a configuration of a charging device according to the ninth embodiment. FIG. 18 illustrates a case where the charging device 1 is viewed from above. FIG. 19 is a sectional view schematically illustrating a configuration of the charging device of FIG. 18. FIG. 19 illustrates a cross section taken along line XIX-XIX in FIG. 18.

As illustrated in FIGS. 18 and 19, the charging device 1 according to the present embodiment is a charging device 1a for a non-magnet compatible terminal device formed as an independent device. Since the magnet 30 is not provided in the non-magnet compatible charging device 1a, it is possible to charge the magnet-compatible terminal device and the non-magnet compatible terminal device at the same time.

Note that, in the configuration in which the positioning of the charging coil 40 and the induction coil is performed by the attraction force between the magnet 30 and the magnet mounted on the terminal device, it is difficult to completely eliminate the influence of the magnetic force applied to the non-magnet compatible terminal device by the magnet 30 of the magnet-compatible charging device 1b. Therefore, there is a possibility that a standard for high-speed charging without magnet attraction is formulated. In this case, by appropriately moving the charging coil 40a to the charging position by the configuration of the charging device 1a according to the present embodiment, it is possible to achieve both the magnet-compatible terminal device and the non-magnet compatible terminal device and to perform charging according to the high-speed charging standard.

### Tenth Embodiment

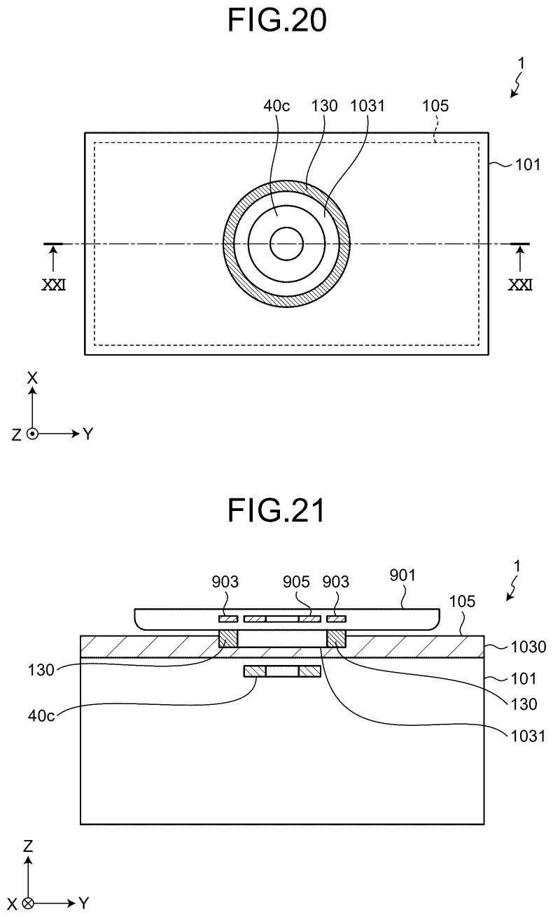

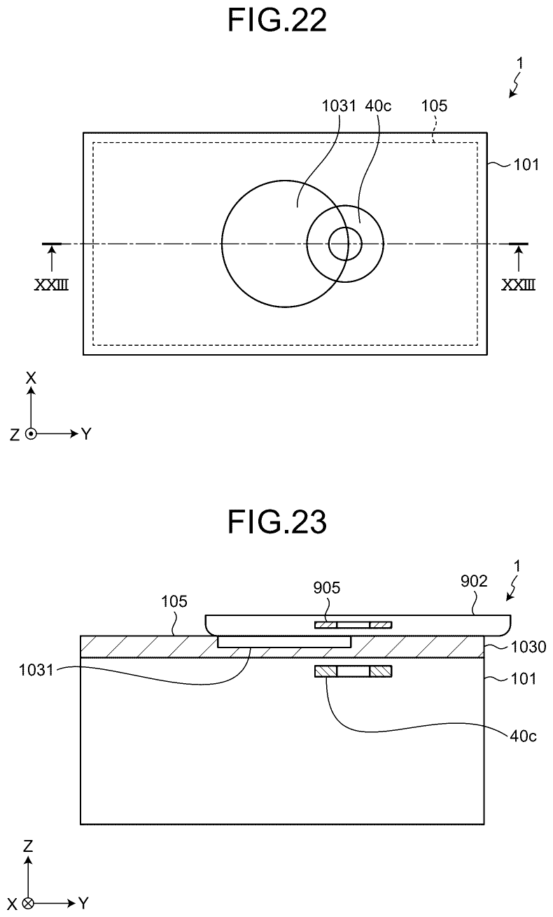

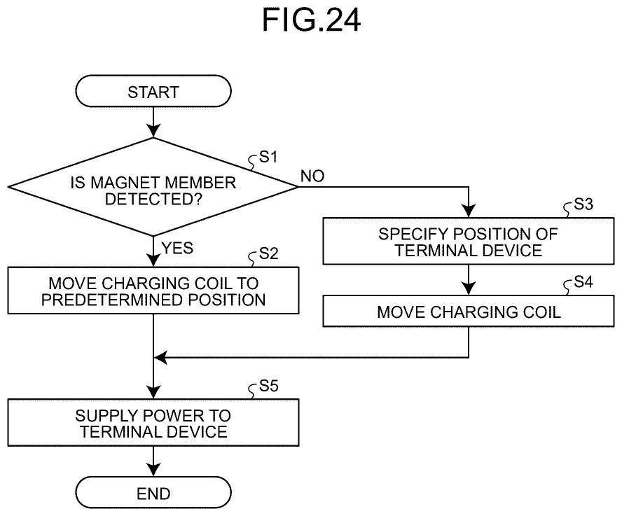

In the present embodiment, differences from the second embodiment will be mainly described. Hereinafter, description will be given with reference to FIGS. 20 to 24. FIGS. 20 and 22 are plan views schematically illustrating a configuration of a charging device 1 according to a tenth embodiment, and illustrate a case where the charging device 1 is viewed from above. FIG. 20 is a plan view illustrating a configuration of the charging device 1 in a case where the terminal device is charged by providing a magnet member 130 in the charging device 1. FIG. 22 is a plan view illustrating a configuration of the charging device 1 in a case where the terminal device is charged without providing the magnet member 130 in the charging device 1. FIG. 21 is a sectional view schematically illustrating a configuration of the charging device 1 of FIG. 20. FIG. 21 illustrates a cross section taken along line XXI-XXI in FIG. 20. FIG. 23 is a sectional view schematically illustrating a configuration of the charging device 1 of FIG. 22. FIG. 23 illustrates a cross section taken along line XXIII-XXIII in FIG. 22. FIG. 24 is a flowchart illustrating an example of an operation of the charging device 1 according to the tenth embodiment.

As illustrated in FIGS. 20 to 23, the charging device 1 according to the present embodiment includes a charging coil 40c as the charging coil 40. In the present embodiment, the charging device 1 does not include the magnet 30 and the moving mechanism 20 for the magnet 30.

The charging device 1 according to the present embodiment includes a panel 1030 instead of the panel 103. A recess 1031 (depression, mounting portion) is formed on the upper surface side of the panel 1030. The magnet member 130 can be detachably disposed in the recess 1031. The magnet member 130 is disposed in the recess 1031 by the user. When charging a magnet-compatible terminal device 901, the user disposes the magnet member 130 in the recess 1031 as illustrated in FIGS. 20 and 21. On the other hand, when charging a non-magnet compatible terminal device 902, the user does not dispose the magnet member 130 in the recess 1031 as illustrated in FIGS. 22 and 23.

As illustrated in FIGS. 20 to 23, for example, the recess 1031 is formed in a circular shape, and the magnet member 130 is formed in an annular shape (ring shape). The shape of the recess 1031 and the shape of the magnet member 130 are not limited to the shapes illustrated in FIGS. 20 to 23, and may be shapes in which at least a part is in contact with each other. As a result, the user can easily fit and dispose the magnet member 130 in the recess 1031.

The magnet member 130 includes a magnet therein. The magnet inside the magnet member 130 is formed in, for example, an annular shape (ring shape). When the magnet member 130 is disposed in the recess 1031, the charging coil 40c of the charging device 1 and an induction coil 905 of the terminal device 901 are aligned by the attraction force between the internal magnet and the magnet 903 mounted on the magnet-compatible terminal device 901. Thus, the shape of the magnet inside the magnet member 130 is designed in accordance with the shape of the magnet 903 mounted on the magnet-compatible terminal device 901.

Note that a plurality of magnets inside the magnet member 130 may be arranged along the circumference of the magnet member 130. In this case, the arrangement position of the magnet inside the magnet member 130 is designed in accordance with the shape of the magnet 903 mounted on the magnet-compatible terminal device 901.

The moving mechanism 20 according to the present embodiment is configured to support the charging coil 40c. The moving mechanism 20 is configured to move the charging coil 40c along the placement surface 105 within the chargeable region under the control of the controller 10.

The charging device 1 according to the present embodiment has a second detection function of detecting the magnet member 130. In the charging device 1, namely, in the second detection function, the processor 11 detects whether or not the magnet member 130 is disposed in the recess 1031 on the basis of, for example, an output of a sensor or a switch provided in the vicinity of the recess 1031. Here, the processor 11 that implements the second detection function is an example of a detection unit. The detection unit may include the above-described sensor or switch.

In the driving function 115 according to the present embodiment, the processor 11 is configured to drive the moving mechanism 20 to move the charging coil 40c to the charging position in the chargeable region. Specifically, the processor 11 moves the charging coil 40c according to the presence or absence of the detection of the magnet member 130. When the magnet member 130 is detected (S1: YES), the processor 11 moves the charging coil 40c to a predetermined position set in advance (S2).

Here, as illustrated in FIG. 21, the predetermined position is a position corresponding to the position of the induction coil 905 mounted on the magnet-compatible terminal device 901. The predetermined position is designed based on the position of the magnet inside the magnet member 130 and the positions of the magnet 903 and the induction coil 905 mounted on the magnet-compatible terminal device 901 when the magnet member 130 is disposed in the recess 1031. In the example illustrated in FIG. 21, the predetermined position is below the central position of the recess 1031 on the X-Y plane, in other words, below the central position of the magnet member 130 on the X-Y plane. As a result, the induction coil 905 and the charging coil 40c of the magnet-compatible terminal device 901 are aligned.

On the other hand, in a case where the magnet member 130 is not detected (S1: NO), the processor 11 determines the position of the terminal device to be charged (S3), and moves the charging coil 40c to the charging position which is a position corresponding to the determined position (S4).

After moving the charging coil 40c, the processor 11 supplies power to the induction coil 905 of the terminal device to be charged by causing the charging coil 40c to transmit power (S5).

According to this configuration, when charging the magnet-compatible terminal device 901, the charging device 1 can easily align the charging coil 40c and the induction coil 905 by the magnet member 130. In addition, when charging the non-magnet compatible terminal device 902, the charging device 1 can align the charging coil 40c and the induction coil 905 without arranging the magnet member 130.

Here, a communication function between the charging device 1 and the terminal device according to each of the above-described embodiments will be described. As described above, the charging coil 40 of the charging device 1 and the induction coil 905 of the terminal device can be electromagnetically coupled, and the charging device 1 and the terminal device communicate with each other using the electromagnetic coupling. For example, by adjusting the loads of the charging coil 40 and the induction coil 905, the charging device 1 and the terminal device transmit data as a variation in the coupling field. Specifically, the charging device 1 transmits data modulated by FSK (Frequency Shift Keying) to the terminal device. Further, when receiving data modulated by load modulation in the terminal device, the charging device 1 demodulates the data. Through these processes, information can be exchanged between the charging device 1 and the terminal device.

In the charging device 1 according to each of the above-described embodiments, the charging coil 40 may be configured to be movable only in one of the X-axis direction and the Y-axis direction below the placement surface 105. In other words, the charging coil 40 according to each embodiment may be configured to be movable in at least one of the X-axis direction and the Y-axis direction below the placement surface 105. In addition, the directions in which the charging coil 40a and the charging coil 40b are movable may be different, for example, one of the charging coil 40a and the charging coil 40b is movable in the X-axis direction and the Y-axis direction, and the other is movable only in one of the X-axis direction and the Y-axis direction.

Note that the charging device 1 according to each of the above-described embodiments can be used as, for example, an in-vehicle device, but is not limited thereto. The wireless charger can be appropriately used as various wireless chargers conforming to a standard such as the Qi standard, such as a device used on a desk.

The program executed by the charging device 1 of the present embodiment is provided by being recorded in a computer-readable recording medium such as a CD-ROM, an FD, a CD-R, or a DVD as a file in an installable format or an executable format.

In addition, the program executed by the charging device 1 of the present embodiment may be stored on a computer connected to a network such as the Internet and provided by being downloaded via the network. In addition, the program executed by the charging device 1 may be provided or distributed via a network such as the Internet.

In addition, the program executed by the charging device 1 of the present embodiment may be provided by being incorporated in a ROM or the like in advance.

According to at least one embodiment described above, wireless charging by the magnet attraction type charging device can be realized regardless of the presence or absence of the magnet to be charged.

Although some embodiments of the present invention have been described, these embodiments have been presented as examples, and are not intended to limit the scope of the invention. These embodiments can be implemented in various other forms, and various omissions, substitutions, and changes can be made without departing from the gist of the invention. These embodiments and modifications thereof are included in the scope and gist of the invention and are included in the invention described in the claims and the equivalent scope thereof.

### Appendix

As is apparent from the above exemplary embodiments, the present disclosure includes the following aspects.

(1)

A charging device that wirelessly charges a terminal device placed on a placement surface and receiving wirelessly transmitted power, the charging device including:
a first charging coil configured to transmit power to the terminal device;
a magnet member detachably provided in a recess formed in a part of the placement surface; and
a moving mechanism configured to move the first charging coil along the placement surface in a chargeable region corresponding to the placement surface.

(2)

The charging device according to the above-described (1), wherein
the magnet member has an annular shape, and,
when the terminal device is a terminal device incorporating a magnet attracted by the magnet member, the first charging coil is moved to a charging position corresponding to inside of the magnet member by the moving mechanism.

(3)

The charging device according to the above-described (2), further including:
a detection unit that detects whether or not the magnet member is placed on the placement surface,
wherein the first charging coil is moved to the charging position by the moving mechanism when the magnet member is detected.

What is claimed is:

1. A charging device wirelessly charging a terminal device, the terminal device being placed on a placement surface and receiving wirelessly transmitted power, the charging device comprising:
a first charging coil configured to transmit power to the terminal device;
a magnet provided outside the first charging coil; and
a moving mechanism configured to move the first charging coil and the magnet along the placement surface within a chargeable region corresponding to the placement surface.

2. The charging device according to claim 1, further comprising a second charging coil configured to transmit power to the terminal device, wherein
the moving mechanism is configured to
move, within the chargeable region, one of the first charging coil or the second charging coil, and
move the other one of the first charging coil or the second charging coil to a retraction region being a region deviated from the chargeable region.

3. The charging device according to claim 2, wherein the moving mechanism is configured to move the magnet to the retraction region together with the first charging coil.

4. The charging device according to claim 1, wherein
the moving mechanism is capable of moving the first charging coil and the magnet independently of each other, and
the moving mechanism is configured to move the magnet to a retraction region while placing the first charging coil within the chargeable region, the retraction region being a region deviated from the chargeable region.

5. The charging device according to claim 2, wherein the retraction region is a region deviated from the chargeable region in a direction along the placement surface.

6. The charging device according to claim 2, wherein the retraction region is a region deviated from the chargeable region in a direction intersecting a direction along the placement surface.

7. The charging device according to claim 1, further comprising a second charging coil configured to transmit power to the terminal device, wherein
the placement surface includes a first placement surface and a second placement surface adjacent to each other in a direction along the placement surface, and
the moving mechanism is configured to
move the first charging coil and the magnet along the first placement surface within a chargeable region corresponding to the first placement surface, and
move the second charging coil and the magnet along the second placement surface in a chargeable region corresponding to the second placement surface.

8. The charging device according to claim 1, further comprising:
a second charging coil configured to transmit power to the terminal device; and
a support base configured to support the first charging coil and the second charging coil, wherein
the moving mechanism is configured to move the support base along the placement surface within the chargeable region.

9. A charging device wirelessly charging a terminal device, the terminal device being placed on a placement surface and receiving wirelessly transmitted power, the charging device comprising:
a first charging coil configured to transmit power to the terminal device;
a magnet fixedly provided in a chargeable region corresponding to the placement surface; and
a moving mechanism configured to move the first charging coil along the placement surface within the chargeable region.

10. The charging device according to claim 9, wherein
the magnet has an annular shape, and
the first charging coil is moved inside the magnet by the moving mechanism when the terminal device is a terminal device incorporating a magnet attracted by the magnet of the charging device.

11. The charging device according to claim 10, wherein the magnet of the charging device is an electromagnet that is turned on when the first charging coil is moved inside the magnet of the charging device by the moving mechanism.

12. A charging device wirelessly charging a terminal device, the terminal device being placed on a placement surface and receiving wirelessly transmitted power, the charging device comprising:
a first charging coil configured to transmit power to the terminal device, the first charging coil being fixedly provided in a region corresponding to the placement surface;
a magnet fixedly provided outside the first charging coil;
second charging coils, each being configured to transmit power to the terminal device;
a support base configured to support the second charging coils; and
a moving mechanism configured to move the support base along the placement surface within a chargeable region corresponding to the placement surface.
